(19) United States
(12) Patent Application Publication
(10) Pub. No.: US 2009/0092206 A1
(43) Pub. Date: Apr. 9, 2009

(54) WIRELESS COMMUNICATION APPARATUS AND WIRELESS COMMUNICATION METHOD USING PLURAL COMMUNICATION CHANNELS HAVING DIFFERENT BANDWIDTHS

(76) Inventor: Hirotsugu KAJIHARA, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/244,211

(22) Filed: Oct. 2, 2008

(30) Foreign Application Priority Data
Oct. 5, 2007 (JP) 2007-262621

(51) Int. Cl. H04L 27/06

(52) U.S. Cl. 375/343

(57) ABSTRACT

A wireless communication apparatus includes a measuring unit, a matched filter, and a control unit. The measuring unit measures an electric power of a received signal. The matched filter is capable of operating as a first filter and a second filter for the received signal. The first and second filters detect a frame in a first and second communication channel, respectively. The second communication channel uses a frequency band including a frequency bands used in the first and third communication channel. The control unit determines whether or not the frame exists in the third communication channel according to a detection result of the measuring unit and the matched filter. The control unit operates the matched filter as the first filter when the frame exists in the third communication channel and operates the matched filter as the second filter when the frame does not exist in the third communication channel.

### CROSS-REFERENCE TO RELATED APPLICATIONS

This application is based upon and claims the benefit of priority from prior Japanese Patent Application No. 2007-262621, filed Oct. 5, 2007, the entire contents of which are incorporated herein by reference.

### BACKGROUND OF THE INVENTION

1. Field of the Invention

The present invention relates to a wireless communication apparatus and a wireless communication method using plural communication channels having different bandwidths. For example, the invention relates to a frame detection method in a wireless LAN communication apparatus.

2. Description of the Related Art

Wireless communication which conforms to an IEEE (Institute of Electrical and Electronics Engineers) 802.11a standard can be cited as an example of a CSMA (Carrier Sense Multiple Access) communication system. In the CSMA communication system, a receiver monitors a communication channel used by itself, and the receiver detects a unique frame format asynchronously transmitted from a transmitter. Usually an already-known signal called a preamble is provided at a head of the frame format used in the CSMA communication system. The receiver detects the frame with the preamble. A detection technique in which a matched filter is used is frequently utilized in detecting the frame with the preamble. For example, the matched filter is disclosed in Taehyeun Ha, Seongjoo Lee, and Jaseok Jim, “Low-complexity correlation system for timing synchronization in IEEE802.11a wireless LANs”, Radio and Wireless Conference, 2003, RAWCON 2003, IEEE Proceedings 10-13 Aug. 2003, page 51-54.

Currently, an IEEE 802.11n standard is being formulated. The communication is conducted in the IEEE 802.11a standard while a 20-MHz band is used as the communication channel, the communication can be conducted in the IEEE 802.11n standard while not only the 20-MHz band but also a 40-MHz band in which the two 20-MHz bands are combined are used as the communication channel. That is, the communication in which the two communication channels are used can be conducted in the IEEE 802.11n standard. The two communication channels are called a primary channel and a secondary channel, respectively. In the IEEE 802.11n standard, the communication can be conducted in the 20-MHz band while only the primary channel is used, and the communication can be conducted in the 40-MHz band while both the channels are used. However, the communication in which only the secondary channel is used is prohibited in the IEEE 802.11n standard. For example, this is disclosed in IEEE P802.11n/D1.04, September 2006.

Therefore, unfortunately, the detection accuracy of the frame is deteriorated merely through applying the conventional matched filter to the IEEE 802.11n standard. That is, the detection accuracy of the frame transmitted in the 40-MHz band is deteriorated when the matched filter is optimized for the primary channel. On the other hand, unfortunately, false detection of the frame transmitted in the secondary channel is easily generated when the matched filter is optimized for the 40-MHz band.

### BRIEF SUMMARY OF THE INVENTION

A wireless communication apparatus according to an aspect of the present invention includes:

a measuring unit which measures an electric power of a received signal to detect whether or not the electric power exceeds a predetermined threshold;

a matched filter which is capable of operating as a first filter and a second filter for the received signal, the first filter being capable of detecting a frame in a first communication channel, the second filter being capable of detecting a frame in a second communication channel, the second communication channel using a frequency band including a frequency band used in the first communication channel and a frequency band used in a third communication channel adjacent to the first communication channel; and

a control unit which determines whether or not the frame exists in the third communication channel according to a detection result of the measuring unit and detection result in the matched filter, the control unit operating the matched filter as the first filter when determining that the frame exists in the third communication channel, the control unit operating the matched filter as the second filter when determining that the frame does not exist in the third communication channel.

A wireless communication method which is capable of using a first communication channel and a second communication channel, the second communication channel having a frequency band including a frequency band used in the first communication channel and a frequency band used in a third communication channel adjacent to the first communication channel, the method according to an aspect of the present invention includes:

measuring a signal intensity of a received signal;

determining whether or not a frame exists in the third communication channel when the signal intensity is not lower than a predetermined threshold; and

optimizing a matched filter which detects the frame for the first communication channel when the frame exists in the third communication channel, or optimizing the matched filter for the second communication channel when the frame does not exist in the third communication channel.

### BRIEF DESCRIPTION OF THE SEVERAL VIEWS OF THE DRAWING

FIG. 1 is a block diagram showing a wireless LAN system according to a first embodiment of the invention;

FIG. 2 shows a frequency band used in the wireless LAN system of the first embodiment;

FIG. 3 is a block diagram showing a wireless communication base station of the first embodiment;

FIG. 4 is a conceptual view of a frame;

FIGS. 5A and 5B are graphs showing an output signal of a matched filter of the first embodiment;

FIG. 6 is a flowchart showing an operation of the wireless communication base station of the first embodiment;

FIG. 7 and FIG. 8 are schematic diagrams showing a state in which the frame is transmitted and received in the wireless LAN system of the first embodiment;

FIG. 9 is a flowchart showing an operation of a wireless communication base station according to a second embodiment of the invention;

FIG. 10 is a block diagram showing a wireless communication base station according to a third embodiment of the invention;

FIG. 11 is a flowchart showing an operation of the wireless communication base station of the third embodiment;

FIG. 12 is a schematic diagram showing a state in which the frame is transmitted and received in a wireless LAN system of the third embodiment;

FIG. 13 is a circuit diagram showing a matched filter according to a first modification of the first to third embodiments; and

FIG. 14 is a circuit diagram showing a matched filter according to a second modification of the first to third embodiments.

### DETAILED DESCRIPTION OF THE INVENTION

### First Embodiment

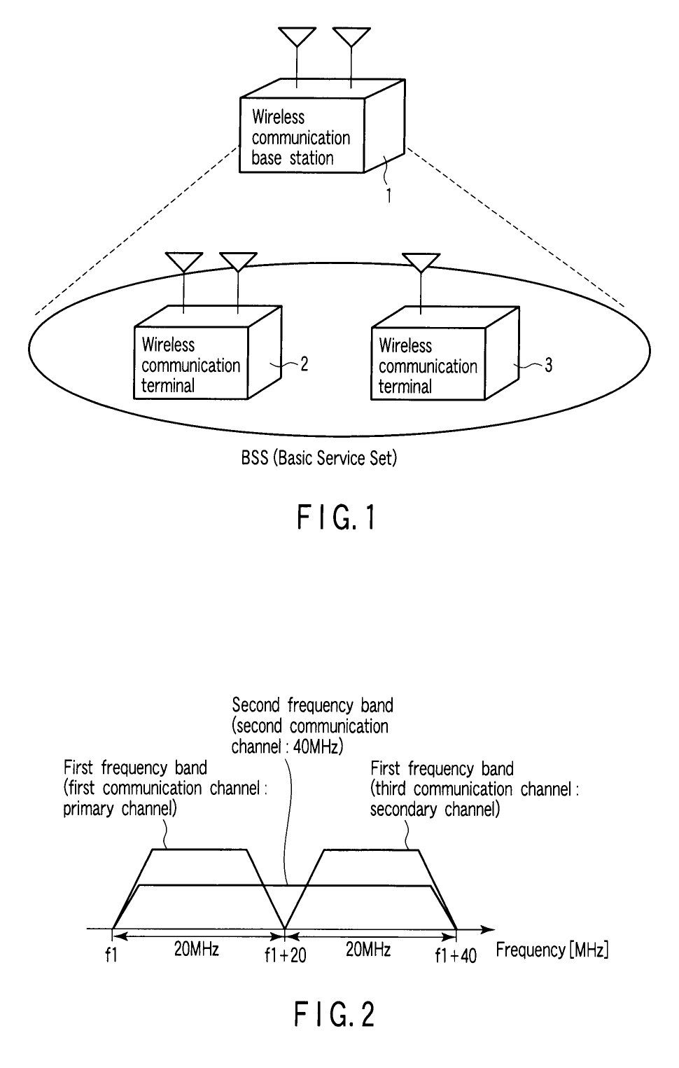

A wireless communication apparatus and a wireless communication method according to a first embodiment of the invention will be described with reference to FIG. 1. FIG. 1 is a conceptual view showing the wireless communication of the first embodiment, and is also a block diagram showing a wireless LAN (wireless Local Area Network) system which conforms to an IEEE 802.11n standard.

Referring to FIG. 1, the wireless LAN system includes a wireless communication base station (hereinafter referred to as access point) 1 and plural wireless communication terminals (hereinafter simply referred to as terminal) 2 and 3. The communication network (for example, LAN) is formed by the access point 1 and the terminals 2 and 3. The terminals 2 and 3 conduct wireless communication with the access point 1 using the 20-MHz frequency band or 40-MHz frequency band. The access point 1 accommodates the terminals 2 and 3 therein to form a BSS (Basic Service Set). For example, the access point 1 is connected to a server (not shown) by a wireless LAN, or the access point 1 is connected to the Internet through an internet service provider by a metal line or an optical fiber. Although the two terminals are included in the BSS in FIG. 1, there is no particular limitation to the number of terminals.

In the first embodiment, each of the access point 1 and terminal 2 includes two antennas, and the terminal 3 includes one antenna. Alternatively, the access point 1 including plural antennas and the terminals 2 and 3 including a single antenna may be mixed in a BSS. One or plural antennas may be mounted on the access point 1 and the terminals 2 and 3 according to a communication system in the wireless LAN system.

(Communication Channel)

A communication channel used in the wireless LAN system of the first embodiment will be described below with reference to FIG. 2. FIG. 2 shows a frequency band used in the wireless LAN system of the first embodiment.

As shown in FIG. 2, in the wireless LAN system, communication can be conducted using two communication channels; a first communication channel and a second communication channel. A first frequency band having the 20-MHz bandwidth from f1 MHz to (f1+20) MHz is used in the first communication channel. A second frequency band having the 40-MHz bandwidth from f1 MHz to (f1+40) MHz is used in the second communication channel. That is, the first frequency band is partially overlapped with the second frequency band. In the second communication channel, the frequency band (band of f1 to (f1+20) MHz) corresponding to the first communication channel is the so-called primary channel, and the band of (f1+20) MHz to (f1+40) MHz is the so-called secondary channel. Hereinafter, sometimes the secondary channel is referred to as third communication channel. That is, in the wireless LAN system of the first embodiment, the wireless communication can be conducted using the first communication channel and the second communication channel, and the second communication channel is the communication channel which can be used by the IEEE 802.11n standard.

In FIG. 2, the secondary channel is located on the high-frequency side of the primary channel. Alternatively, the secondary channel may be located on the low-frequency side of the primary channel. The bandwidths of the primary channel and secondary channel are not limited to 20 MHz, and the bandwidths may be 40 MHz. In this case, the bandwidth of the second communication channel becomes 80 MHz.

(Configurations of Access Point and Terminal)

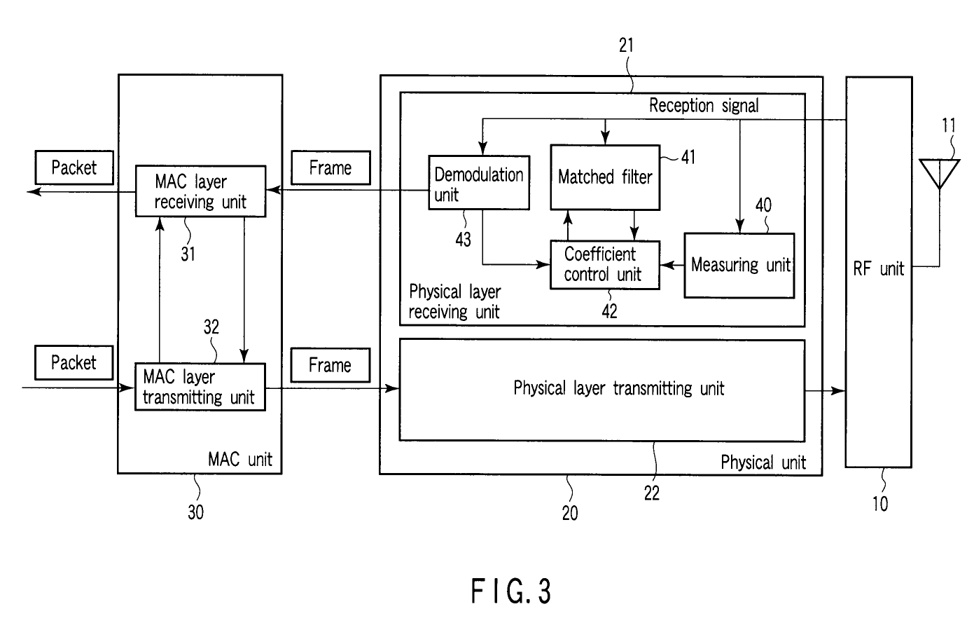

Configurations of the access point 1 and terminals 2 and 3 will be described. Because the access point 1 and the terminals 2 and 3 have substantially the same configuration, only the configuration of the access point 1 will be described below. FIG. 3 is a block diagram showing the access point 1. As shown in FIG. 3, the access point 1 includes an RF (Radio Frequency) unit 10, an antenna 11, a physical unit 20, and a MAC (Media Access Control) unit 30.

The RF unit 10 transmits and receives signals of a high frequency band used for communication on a wireless transmission path to, for example, amplify data in the transmitted and received analog signals. Then, the RF unit 10 transmits and receives the data through an antenna 11. In transmitting the data, the RF unit 10 up-converts the analog signal supplied from the physical unit 20 into a 5-GHz-band RF signal, and the RF unit 10 transmits the 5-GHz-band RF signal to the terminals 2 and 3 from the antenna 11. On the contrary, in receiving the data, the RF unit 10 down-converts the 5-GHz-band RF signal received by the antenna 11, and the RF unit 10 outputs the down-converted signal to the physical unit 20.

The physical unit 20 and the MAC unit 30 perform processing on a physical layer and MAC layer of each of the transmitted data and received data, respectively. The physical unit 20 and the MAC unit 30 will be described in detail.

The physical unit 20 will be described below. The physical unit 20 includes a physical layer receiving unit 21 and a physical layer transmitting unit 22.

The physical layer receiving unit 21 obtains a digital signal by performing A/D conversion on the received signal (down-converted signal: analog signal) supplied from the RF unit 20. Then, the physical layer receiving unit 21 performs demodulation processing on the digital signal. That is, for example, the physical layer receiving unit 21 performs Orthogonal Frequency Division Multiplexing (OFDM) modulation and error correction decoding to obtain a frame (received frame). The physical layer receiving unit 21 outputs the frame to the MAC unit 30. The physical layer receiving unit 21 also detects a frame from the received signal by a detection technique in which the matched filter is used. A configuration and an operation relating to the frame detection are described later.

The physical layer transmitting unit 22 receives a frame (transmission frame) to be transmitted and a transmission rate from the MAC unit 30. The physical layer transmitting unit 22 performs redundant encoding and OFDM conversion on the frame. Then, the physical layer transmitting unit 22 performs D/A conversion to obtain the analog signal, and the physical layer transmitting unit 22 outputs the analog signal as the transmission signal to the RF unit 10. The physical layer transmitting unit 22 transmits the frame to the terminals 2 and 3 through the RF unit 10 and the antenna 11 at the transmission rate defined by the MAC unit 30.

The MAC unit 30 will be described. The MAC unit 30 includes an MAC layer receiving unit 31 and an MAC layer transmitting unit 32.

The MAC layer receiving unit 31 will be described. The MAC layer receiving unit 31 receives the frame from the physical layer receiving unit 21. The MAC layer receiving unit 31 removes a MAC header from the frame to obtain a packet. As used herein, the packet shall mean one in which the transmission data or received data is built up into a data structure handled by a personal computer, and the frame shall mean the transmission data or received data which is built up so as to be able to conduct communication through the wireless communication. When the received frame is a data frame, the frame is transmitted to a data processing unit such as the personal computer (not shown) which further performs processing to an upper-level layer. On the other hand, when the received frame is a frame such as a control frame which is used in protocol processing in the MAC layer, the frame is processed in the MAC layer receiving unit 31. A transmission acknowledge frame can be cited as an example of a control frame.

The MAC layer transmitting unit 32 will be described. The MAC layer transmitting unit 32 receives the transmission data in the form of the packet from a transmission data generation unit (not shown). The transmission data generation unit is a block which produces the transmission data. For example, the transmission data generation unit is a personal computer. The MAC layer transmitting unit 32 builds up the frame (transmission frame) by performing transmission-frame generation processing in which a MAC header is added to the packet or the like. The MAC layer transmitting unit 32 outputs the built-up frame and the transmission rate used in transmitting the frame to the physical layer transmitting unit 22.

The configuration of the physical layer receiving unit 21 will be described below while attention is particularly focused on a block relating to frame detection. Referring to FIG. 3, the physical layer receiving unit 21 includes a measuring unit 40, a matched filter 41, a coefficient control unit 42, and a demodulation unit 43.

The measuring unit 40 measures the electric power of the received signal (down-converted signal) supplied from the RF unit 10. When an electric power having an intensity not lower than a threshold with respect to a background noise is detected, the measuring unit 40 determines that the frame is transmitted through one of the first to third communication channels, and the measuring unit 40 outputs a detection signal to the coefficient control unit 42. That is, the measuring unit 40 outputs “1” as the detection signal when the electric power is not lower than the threshold, and the measuring unit 40 outputs “0” as the detection signal when the electric power is lower than the threshold, for example. For example, the following method can be adopted as the method in which the measuring unit 40 detects the frame. The measuring unit 40 determines that a frame exists when the intensity of the received signal at a certain time is larger than the intensity before 3 μs of observation of the received signal by 10 dB or more, and when the intensity of the received signal at a certain time is larger than the intensity after 10 μs of observation of the received signal by 10 dB or more.

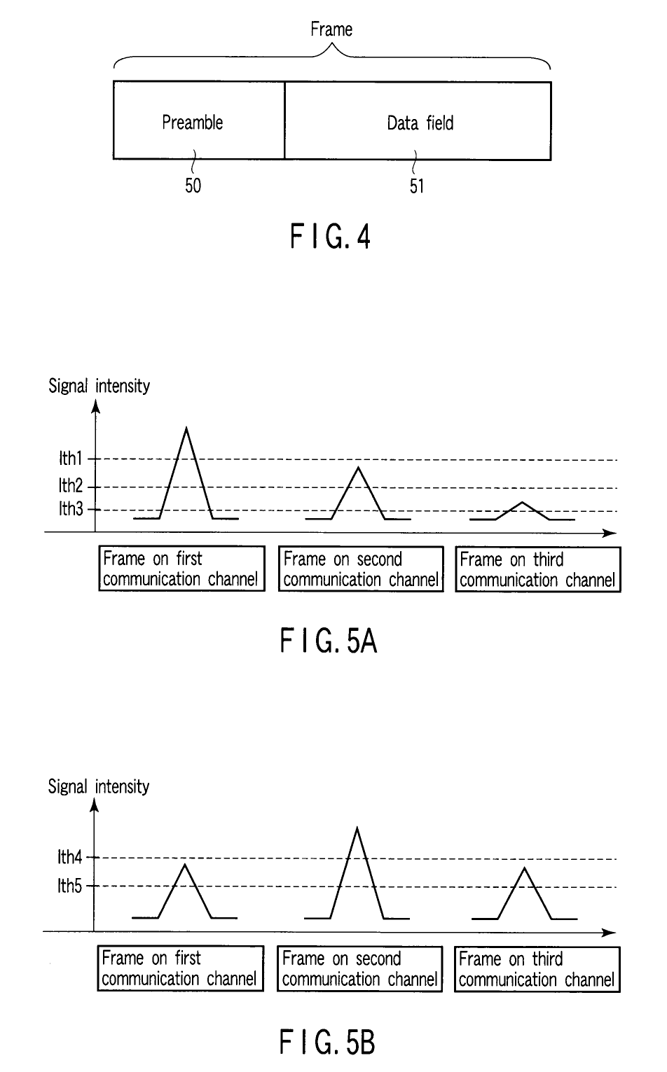

The matched filter 41 detects the frame for the received signal (down-converted signal) supplied from the RF unit 10. The matched filter 41 outputs the detection result to the coefficient control unit 42 and the demodulation unit 43. That is, based on the preamble of the frame, the matched filter 41 detects whether or not the frame exists in the first communication channel and detects whether or not the frame exists in the second communication channel. In order to detect a frame, the matched filter 41 acts as either a first filter passing the frame through the first communication channel or a second filter passing the frame through the second communication channel. The matched filter 41 compares an output of the first filter or second filter with a threshold, and the matched filter 41 outputs the comparison result to the coefficient control unit 42. The matched filter 41 outputs “1” when determining that the frame exists, and outputs “0” when determining that the frame does not exist, for example. A configuration of the frame will be described below with reference to FIG. 4. FIG. 4 is a conceptual view showing the configuration of the frame which conforms to the IEEE 802.11 standard.

Referring to FIG. 4, the frame roughly includes a preamble 50 and a data field 51. As described above, the preamble 50 is the already-known signal used to synchronize the transmitted data and received data. More particularly, the preamble 50 includes an L-STF (Legacy-Short Training Field), L-LTF (Legacy-Long Training Field), L-SIG (Legacy-Signal Field), HT-STF (High Throughput-STF), HT-LTF (High Throughput-LTF), and HT-SIG (High Throughput-SIG).

L-STF, L-LTF, and L-SIG are information which is used to transmit and receive the frame pursuant to the IEEE 802.11a standard in a communication environment pursuant to the IEEE 802.11n standard. That is, the preamble of the frame to be transmitted only through the first communication channel includes L-STF, L-LTF, and L-SIG, and the preamble does not include HT-STF, HT-LTF, and HT-SIG.

On the other hand, HT-STF, HT-LTF, and HT-SIG are information which is used to transmit and receive the frame pursuant to the IEEE 802.11n standard. That is, the preamble of the frame to be transmitted through the second communication channel includes not only L-STF, L-LTF, and L-SIG, but also HT-STF, HT-LTF, and HT-SIG. L-STF, L-LTF, and L-SIG may be omitted in transmitting and receiving the frame between the wireless communication apparatuses pursuant to the IEEE 802.11n standard.

L-STF and HT-STF are fields which are used when synchronous processing is performed to receive the signal, and L-STF and HT-STF are mainly used in frame detection or timing detection. L-LTF and HT-LTF are fields which are used when synchronous processing is performed to receive the signal, and L-LTF and HT-LTF are mainly used to correct an error of a carrier frequency and to detect a reference amplitude and phase. L-SIG and HT-SIG retain pieces of information such as a length, a transmission speed, and a modulation system of data included in the data field of the frame.

The data field 51 roughly includes a MAC header, a frame body, and FCS (Frame Check Sequence). The MAC header is necessary information to perform processing of the MAC layer. For example, the MAC header includes pieces of information on a transmission source and destination of the data and a type of frame. The frame body retains net data which should be transmitted to the transmission destination by the frame. FCS is, for example, CRC (Cyclic Redundancy Code) which is used to determine whether or not the MAC header and the frame body are normally received.

As described above, the frame existing in the first communication channel and the frame existing in the second communication channel differ from each other in the preamble. Therefore, the matched filter 41 functions as the first filter or the second filter to detect which communication channel the frame exists in. The frame detection performed by the matched filter 41 will be described below with reference to FIGS. 5A and 5B. FIG. 5A shows a filter output when the matched filter 41 functions as the first filter, FIG. 5B shows a filter output when the matched filter 41 functions as the second filter, and FIGS. 5A and 5B show the case in which the frames exist in the first to third communication channels.

First, the case of FIG. 5A will be described. When the matched filter 41 functions as the first filter, a detection characteristic of the matched filter 41 is optimized for the frame of the first communication channel (primary channel). Accordingly, the output is increased when the frame of the first communication channel is received (>Ith1). That is, the frame detection accuracy is enhanced for the frame of the first communication channel.

On the other hand, the output is decreased when the frame of the third communication channel (secondary channel) is received (<Ith2, Ith2 is smaller than Ith1). That is, the frame detection accuracy is lowered for the frame of the third communication channel. When the frame of the second communication channel (40 MHz) is received, because the frame also includes a component of the first communication channel, the output is larger than Ith2 while being smaller than Ith1.

Accordingly, the matched filter 41 determines the output of the first filter using the intensity of the threshold Ith2, thereby detecting the frame of the first communication channel and the frame of the second communication channel.

The case of FIG. 5B will be described. When the matched filter 41 functions as the second filter, the detection characteristic of the matched filter 41 is optimized for the frame of the second communication channel (40-MHz band). Accordingly, the output is increased when the frame of the second communication channel is received (>Ith4). That is, the frame detection accuracy is enhanced for the frame of the second communication channel.

On the other hand, the output is decreased when the frame of the first communication channel (primary channel) and the frame of the third communication channel (secondary channel) are received (<Ith4). The frame received through the first communication channel and the frame received through the third communication channel become substantially similar to each other in the filter output. At this point, the matched filter 41 determines the output of the second filter using the intensity of the threshold Ith4, thereby detecting the frame of the second communication channel.

Hereinafter, sometimes the state in which the matched filter 41 functions as the first filter is referred to as a first operating mode, and the state in which the matched filter 41 functions as the second filter is referred to as a second operating mode.

Referring to FIG. 3, the description of the configuration of the physical layer receiving unit 21 will be continued.

The demodulation unit 43 performs the demodulation processing (OFDM modulation and error correction decoding) on the data field 51 of the frame when the frame is detected in the matched filter 41. In addition to the demodulation processing, the demodulation unit 43 analyzes the MAC header, and the demodulation unit 43 outputs the analytical result to the coefficient control unit 42.

The coefficient control unit 42 determines whether the frame exists in the third communication channel (secondary channel) or not based on the detection signal supplied from the measuring unit 40 and the determination result of the matched filter 41. The coefficient control unit 42 selectively applies a filter coefficient to the matched filter based on the determination result of the coefficient control unit 42, which allows the matched filter 41 to function as the first filter or the second filter.

(Operations of Access Point and Terminal)

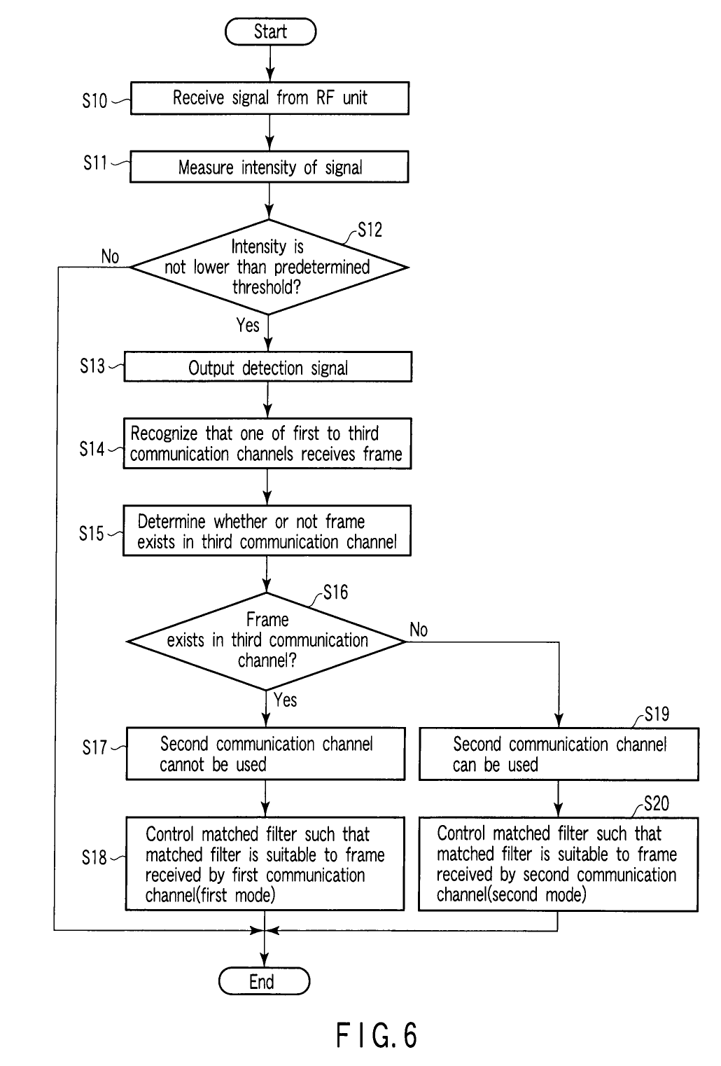

Referring to FIG. 6, an operation of the access point 1 and the terminals 2 and 3 having the above-described configuration will be described with particular focus on control of the matched filter. FIG. 6 is a flowchart showing the operation of the access point 1. Although the operation of the access pint 1 is described below by way of example, the operations of the terminals 2 and 3 are similar to those of the access point 1.

The access point 1 receives the RF signal through the antenna 11 using the RF unit 10. The RF signal down-converted by the RF unit 10 is supplied to the physical layer receiving unit 21 as the received signal (Step S10).

The measuring unit 40 measures the intensity of the received signal (Step S11). As a result of the measurement, when the intensity of the received signal is lower than a constant threshold with respect to the background noise (NO in Step S12), the measuring unit 40 determines that the frame is not received, and processing is not performed any more.

When the intensity of the received signal is not lower than the constant threshold (YES in Step S12), the measuring unit 40 determines that the frame is received, and the measuring unit 40 outputs the detection signal to the coefficient control unit 42 (Step S13). Consequently, the coefficient control unit 42 recognizes that the frame exists in one of the first to third communication channels (Step S14). The coefficient control unit 42 determines whether or not the frame exists in the third communication channel (secondary channel) based on the detection signal of the measuring unit 40, the determination result of the matched filter 41, and the analytical result of the demodulation unit 43 (Step S15).

As a result of processing in Step S15, when the frame exists in the third communication channel (YES in Step S16), the coefficient control unit 42 determines that the second communication channel cannot be used (Step S17). Therefore, the coefficient control unit 42 selects the filter coefficient such that the filter coefficient is suitable for the frame detection of the first communication channel, and the coefficient control unit 42 applies the selected filter coefficient to the matched filter 41 (Step S18). The matched filter 41 becomes the first mode to function as the first filter. That is, the matched filter 41 performs the operation of FIG. 5A.

On the contrary, when the frame does not exist in the third communication channel (NO in Step S16), the coefficient control unit 42 determines that the second communication channel can be used (Step S19). Therefore, the coefficient control unit 42 selects the filter coefficient such that the filter coefficient is suitable for the frame detection of the second communication channel, and the coefficient control unit 42 applies the selected filter coefficient to the matched filter 41 (Step S20). The matched filter 41 becomes the second mode to function as the second filter. That is, the matched filter 41 performs the operation of FIG. 5B.

(Effect)

Thus, the wireless communication apparatus of the first embodiment obtains the following effect (1).

(1) The frame detection accuracy can be enhanced.

As described in the background, unfortunately, the frame detection accuracy is deteriorated through simply applying the conventional matched filter to the wireless communication apparatus which conforms to the IEEE 802.11n standard. This point will be described with reference to FIGS. 5A and 5B.

As shown in FIG. 5A, when the matched filter is optimized for the primary channel, unfortunately, the frame detection accuracy is lowered in the 40-MHz band while the frame detection accuracy is enhanced in the primary channel.

As shown in FIG. 5B, when the matched filter is optimized for the 40-MHz band, the frame detection accuracy is lowered in the primary channel while the frame detection accuracy is enhanced in the 40-MHz band. Therefore, it is necessary to lower a threshold level of the matched filter. However, unfortunately, false frame detection of the secondary channel is easily generated when the threshold level of the matched filter is excessively lowered.

On the other hand, in the configuration of the first embodiment, the coefficient control unit 42 controls the operation of the matched filter 41 according to the existence of the frame in the secondary channel, so that the frame detection accuracy can be enhanced. The effect (1) will be described below.

(1-1) The Case where the Frame Exists in the Secondary Channel (Third Communication Channel)

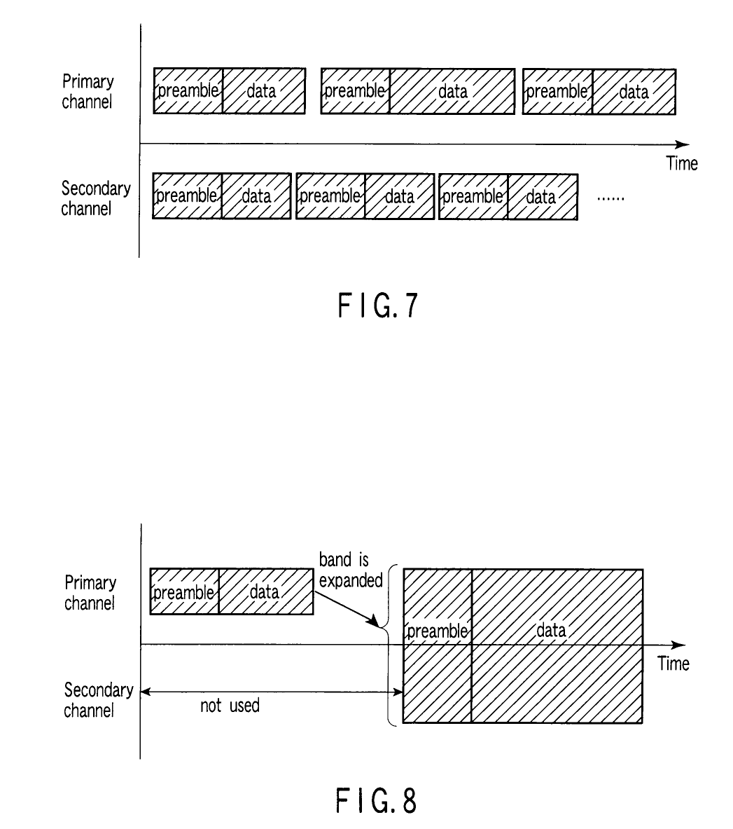

The communication in which only the secondary channel is used is prohibited as described above. The existence of the frame in the secondary channel despite this shall mean that another wireless LAN system uses its secondary channel as the primary channel. Accordingly, in the wireless LAN system which accommodates the wireless communication apparatus, the communication cannot be conducted in the 40-MHz band including the frequency band of the secondary channel. That is, the wireless communication apparatus cannot use the second communication channel, but the wireless communication apparatus has to conduct the communication in which only the first communication channel is used. FIG. 7 is a schematic diagram showing the state in which the frame is transmitted and received in the primary channel and secondary channel. As shown in FIG. 7, the secondary channel is used by another wireless LAN system. Accordingly, the secondary channel cannot be used and the frame shouldn't be detected in the secondary channel.

Therefore, the coefficient control unit 42 causes the matched filter 41 to function as the first filter. That is, the matched filter 41 functions as the filter which is more suitable for the frame detection in the first communication channel (primary channel) than the second communication channel. The operation of the first filter is already described with reference to FIG. 5A.

Because the secondary channel is an exclusive communication channel relative to the primary channel, the matched filter 41, which functions as the first filter, does not detect the frame in the secondary channel. Accordingly, false frame detection can be prevented in the secondary channel. As a result, the demodulation unit 43 can be prevented from performing the unnecessary demodulation processing of the frame in the secondary channel, which allows a reduction of the electric power consumption.

The matched filter 41 functions as the first filter, whereby the frame detection accuracy of the matched filter 41 is lowered in the 40-MHz band. However, in this case, the frame is rarely transmitted in the 40-MHz band. This is because the secondary channel is already used by another wireless LAN system. Accordingly, even if the frame detection accuracy is lowered in the 40-MHz band, the problem is not generated in actual use. Even if the frame is transmitted in the 40-MHz band after another wireless LAN wireless terminates communication using the secondary channel, because the matched filter 41, which functions as the first filter, can detect the frame, the problem is not generated in this case. The communication in the 40-MHz band can be continued depending on the usage frequency of the secondary channel.

That is, the matched filter 41 functions as the first filter, whereby the frame detection accuracy can be enhanced to prevent a missing out a frame in the first communication channel of a high usage frequency. The frame of the second communication channel can also be received to improve the throughput. The frame of the third communication channel unnecessary for the communication can be ignored to prevent false frame detection.

(1-2) The Case in which the Frame does not Exist in the Secondary Channel (Third Communication Channel)

When the frame does not exist in the secondary channel, the communication can be conducted in the 40-MHz band including the primary channel and the secondary channel. FIG. 8 shows the state in which the communication can be conducted in the 40-MHz band including the primary channel and secondary channel. As shown in FIG. 8, the communication band can be expanded from the 20-MHz band to the 40-MHz band unless the frame exists in the secondary channel.

Therefore, the coefficient control unit 42 causes the matched filter 41 to function as the second filter. That is, the matched filter 41 acts as the filter which is more suitable for the frame detection in the second communication channel (40-MHz band) than the first communication channel. The operation of the second filter is already described with reference to FIG. 5B.

Therefore, the frame detection accuracy can be enhanced in the 40-MHz band. At this point, because the frame detection accuracy is lowered in the primary channel, the matched filter 41 has to lower the threshold thereof. This enables the frame of the secondary channel to be also detected in addition to the frame of the primary channel. However, because the communication using only the secondary channel is not conducted, the problem of the false detection is not generated.

That is, the matched filter 41 functions as the second filter, whereby the frame detection accuracy can be enhanced to prevent a missing out a frame in the third communication channel having a high usage frequency. The frame of the first communication channel can also be received to improve the throughput. In this case, because the frame does not exist in the third communication channel, false frame detection can be prevented even if the matched filter 41 functions as the second filter.

### Second Embodiment

A wireless communication apparatus and a wireless communication method according to a second embodiment of the invention will be described below. The second embodiment relates to a method for determining whether or not the frame exists in the third communication channel using the coefficient control unit 42 of the first embodiment. Accordingly, because other configurations and operations of the second embodiment are similar to those of the first embodiment, only the points that are different from the first embodiment will be described below.

(Method for Determining Whether Frame Exists in Third Communication Channel)

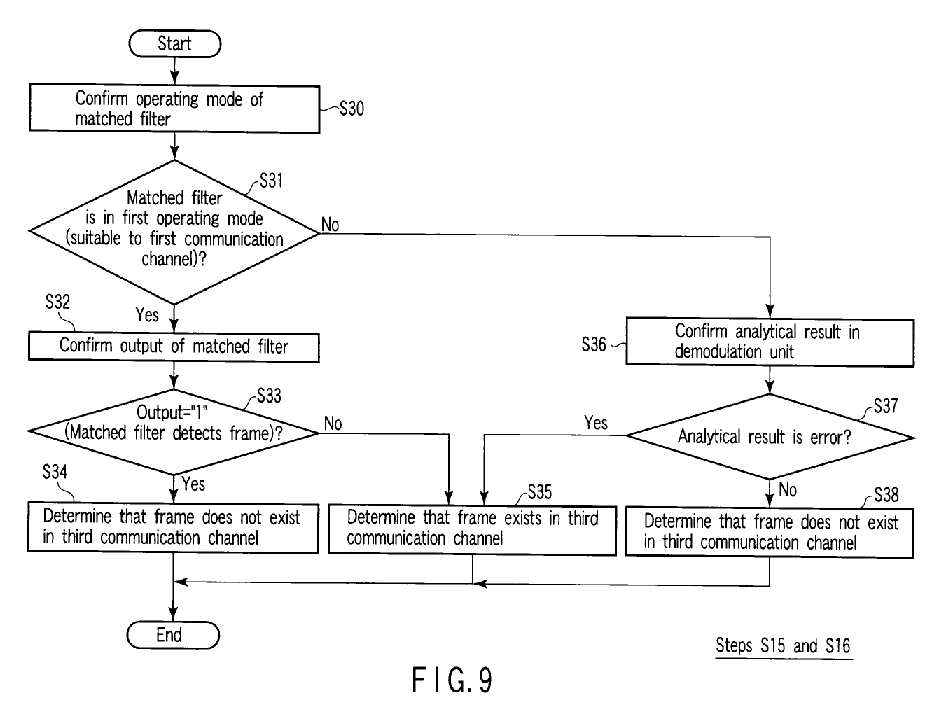

The operation of the coefficient control unit 42 will be described below in detail with reference to FIG. 9. FIG. 9 is a flowchart showing the operation of the coefficient control unit, and the flowchart of FIG. 9 corresponds to Step S15 and S16 of the first embodiment.

As shown in FIG. 9, after recognizing that the frame exists in one of the first to third communication channels, the coefficient control unit 42 confirms the current operating mode of the matched filter 41 (Step S30).

When the matched filter 41 is in the first operating mode (YES in Step S31), that is, when the matched filter 41 functions as the first filter, the coefficient control unit 42 confirms the determination information supplied from the matched filter 41 (Step S32). When the matched filter 41 detects the frame in the first communication channel (YES in Step S33), that is, when the matched filter 41 has the output signal of “1”, the coefficient control unit 42 determines that the frame does not exist in the third communication channel (Step S34).

When the matched filter 41 does not detect the frame in the first communication channel (NO in Step S33), that is, when the matched filter 41 has the output signal of “0”, the coefficient control unit 42 determines that the frame exists in the third communication channel (Step S35).

When the matched filter 41 is in the second operating mode (NO in Step S31), that is, when the matched filter 41 functions as the second filter, the coefficient control unit 42 confirms the analytical result of the demodulation unit 43 (Step S36). When the demodulation unit 43 sends back an error as the analytical result to the coefficient control unit 42 (YES in Step S37), the coefficient control unit 42 determines that the frame exists in the third communication channel (Step S35). On the other hand, when the error is not generated (NO in Step S37), the coefficient control unit 42 determines that the frame does not exist in the third communication channel (Step S38).

(Effect)

Thus, the wireless communication apparatus of the second embodiment obtains the following effect (2) in addition to the effect (1) of the first embodiment.

(2) The determination as to whether or not the frame exists in the third communication channel can be made with high accuracy.

In the configuration of the second embodiment, the coefficient control unit 42 determines whether or not the frame exists in the third communication channel based on either the output of the matched filter 41 or the analytical result of the demodulation unit 43 according to the state of the matched filter 41. Accordingly, the determination of whether the frame exists in the third communication channel can be made with high accuracy. The effect (2) will be described below.

(2-1) The Case in which the Matched Filter 41 Functions as the First Filter

As described in the first embodiment, the frame of the third communication channel is not detected by the matched filter 41 which functions as the first filter.

Accordingly, when the frame is detected by the matched filter 41 is such cases, it is found that the communication channel in which the frame exists is not the third communication channel. That is, the frame is not one which is transmitted only through the secondary channel.

On the other hand, when the matched filter 41 does not detect the frame although the measuring unit 40 measures the electric power, it is found from the characteristic of the matched filter 41 that the communication channel in which the frame exists is the third communication channel. That is, the frame is one which is transmitted only through the secondary channel.

The determination can be made by monitoring whether or not the measuring unit 40 outputs a signal indicating a detection of the electric power for a predetermined time interval and whether or not the matched filter 41 outputs a signal indicating a detection of a frame. For example, the determination can be realized with a simple circuit such as a timer counter.

(2-2) The Case in which the Matched Filter 41 Acts as the Second Filter

As described in the first embodiment, the matched filter 41 which functions as the second filter detects the frames in the first to third communication channels. Accordingly, the determination of which communication channel the frame exists in cannot be made only from the output of the matched filter 41.

Therefore, the analytical result of the demodulation unit 43 is used in the second embodiment. Because the frames in the first communication channel and second communication channel are addressed to the access point 1 or terminal 2, 3 in the noticed BSS, the demodulation unit 43 of the addressed access point 1 or addressed terminal 2, 3 can normally demodulate the frame. However, the frame in the third communication channel is not addressed to the access point 1 or terminal 2, 3 in the noticed BSS. In this case, the demodulation unit 43 sends back an error as the analytical result to the coefficient control unit 42. Accordingly, the determination can be made based on whether or not the analytical result of the demodulation unit 43 is the error.

In the wireless communication, a signal field in which the transmission rate and the length of the transmitted data are accommodated is transmitted after the preamble. The error detection code (such as CRC described with reference to FIG. 4) is given to the signal field (corresponding to the data field 51 of FIG. 4). The demodulation unit 43 sends back the error when the error is detected based on the error detection code. That is, the demodulation unit 43 performs the demodulation as if the received frame is the frame of the primary channel whether the frame of the primary channel or the frame of the secondary channel. Accordingly, when the received frame is the frame of the secondary channel, a value included in the signal field becomes a random value to an extent in which the demodulation unit 43 hardly performs the demodulation. In such cases, the demodulation unit 43 outputs the error because the demodulation unit 43 cannot correctly demodulate the received frame.

The determination can be realized by an extremely simple circuit because the determination is sufficiently made based on the detection of whether or not the analytical result is the error.

### Third Embodiment

A wireless communication apparatus and a wireless communication method according to a third embodiment of the invention will be described below. The third embodiment relates to a timing at which the operating mode of the matched filter 41 is switched in the first and second embodiments. Only the points that are different from the first and second embodiments will be described below.

(Configuration of Coefficient Control Unit)

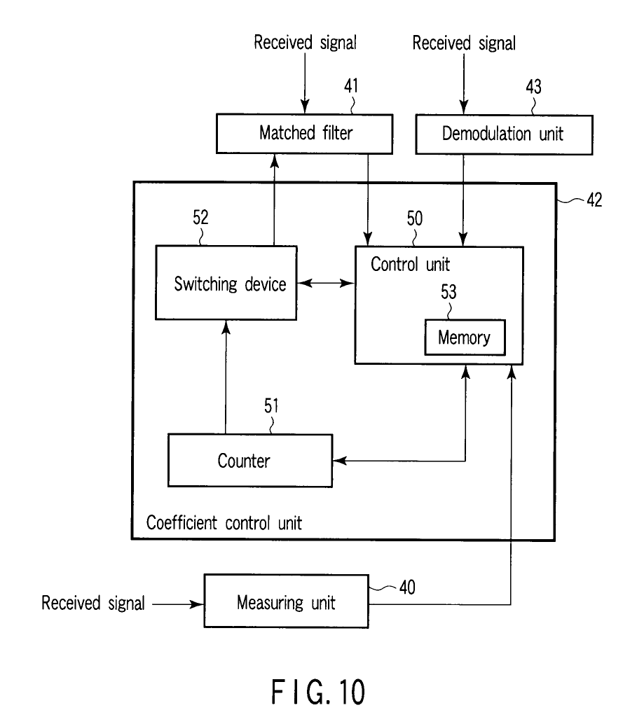

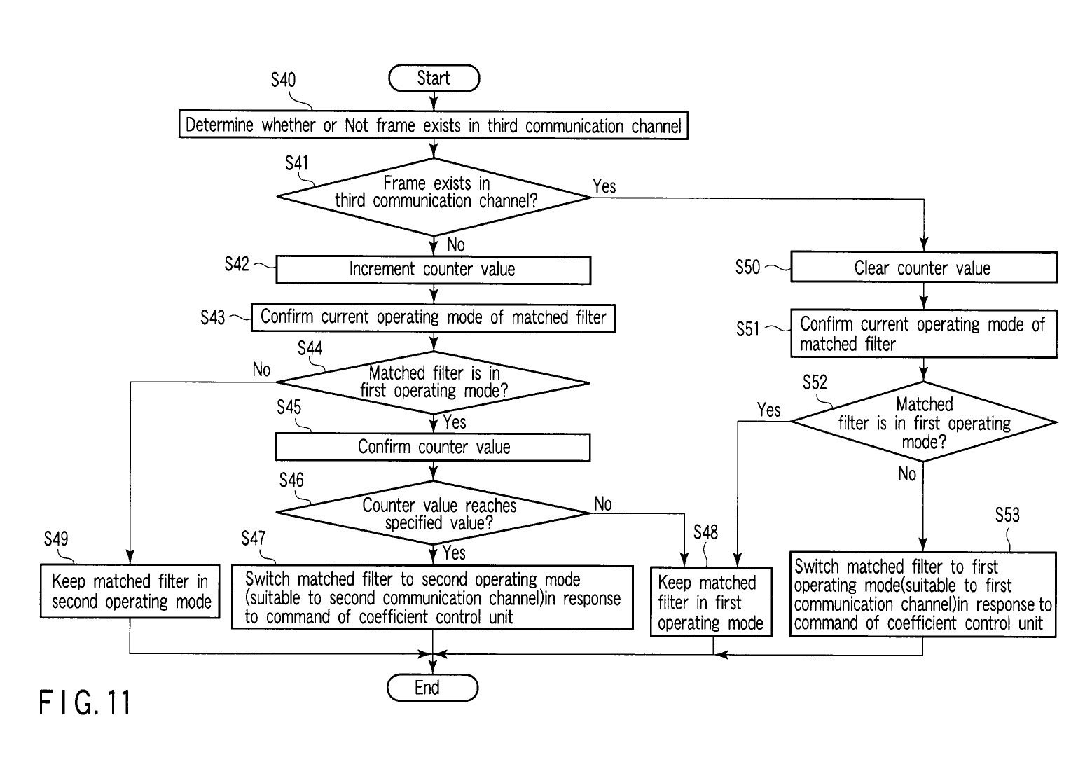

A configuration of the coefficient control unit 42 of the third embodiment will be described with reference to FIG. 10. FIG. 10 is a block diagram showing a physical layer receiving unit 21 of the third embodiment of the invention. As shown in FIG. 10, the coefficient control unit 42 includes a control unit 50, a counter 51, and a switching device 52.

The control unit 50 receives the detection signal from the measuring unit 40 and the analytical result from the demodulation unit 43 to determine whether or not the received frame exists in the third communication channel. When the control unit 50 determines that the frame exists in the first communication channel or second communication channel, the control unit 50 instructs the counter 51 to increment the counter value. The control unit 50 includes a memory 53, and a specified value N (N is a natural number) is stored in the memory 53. The control unit 50 compares the counter value of the counter 51 and the specified value N.

The counter 51 increments the counter value in response to the instruction of the control unit 50, and the counter 51 counts the number of times in which the frame is received through the first communication channel or second communication channel.

The switching device 52 switches the operating mode of the matched filter 41 from the first operating mode to the second operating mode or from the second operating mode to the first operating mode in response to an instruction of the control unit 50.

(Operation of Coefficient Control Unit)

An operation of the coefficient control unit 42 will be described below with reference to FIG. 11. FIG. 11 is a flowchart showing the operation of the coefficient control unit 42, and shows details of the processing after Step S15 of the first embodiment.

As shown in FIG. 11, the control unit 50 determines whether or not the frame exists in the third communication channel (Step S40). For example, the method described in the second embodiment can be adopted as the specific determination method.

When the frame does not exist in the third communication channel as the result of Step S40 (NO in Step S41), the control unit 50 instructs the counter 51 to increment the counter value. The counter 51 increments the counter value by “+1” in response to the instruction (Step S42). Then, the control unit 50 confirms the current operating mode of the matched filter 41 (Step S43). When the matched filter 41 is in the first operating mode (YES in Step S44), that is, when the matched filter 41 functions as the first filter, the control unit 50 confirms the counter value of the counter 51 and compares the counter value with the specified value stored in the memory 53 (Step S45).

As a result of Step S45, when the counter value reaches the specified value (YES in Step S46), the control unit 50 instructs the switching device 52 to switch the matched filter 41 from the first operating mode to the second operating mode. The switching device 52 switches the matched filter 41 from the first operating mode to the second operating mode in response to the switching instruction. That is, the filter coefficient of the matched filter 41 is changed to cause the matched filter 41 to function as the second filter (Step S47).

As a result of Step S45, when the counter value does not reach the specified value (NO in Step S46), the control unit 50 does not instruct switching device to switch (the switching instruction is not issued). Accordingly, the matched filter 41 is kept in the first operating mode (Step S48). That is, the matched filter 41 continuously functions as the first filter.

As a result of Step S43, when the matched filter 41 is not in the first operating mode (NO in Step S44), that is, when the matched filter 41 functions as the second filter, the control unit 50 does not issue the switching instruction. Accordingly, the matched filter 41 is kept in the second operating mode (Step S49). That is, the matched filter 41 continuously functions as the second filter.

The case in which the frame exists in the third communication channel (YES in Step S41) will be described below. In this case, the control unit 50 instructs the counter 51 to clear the counter value. The counter 51 sets the counter value at “0” in response to the instruction (Step S50). Then, the control unit 50 confirms the current operating mode of the matched filter 41 (Step S51). When the matched filter 41 is in the first operating mode (YES in Step S52), the flow goes to the processing in Step S48. That is, the matched filter 41 is kept in the first operating mode.

When the matched filter 41 is not in the first operating mode (NO in Step S52), that is, when the matched filter 41 functions as the second filter, the control unit 50 instructs the switching device 52 to switch the matched filter 41 from the second operating mode to the first operating mode. The switching device 52 switches the matched filter 41 from the second operating mode to the first operating mode in response to the switching instruction. That is, the filter coefficient of the matched filter 41 is changed to cause the matched filter 41 to function as the first filter (Step S47).

(Specific Example of Operation of Coefficient Control Unit)

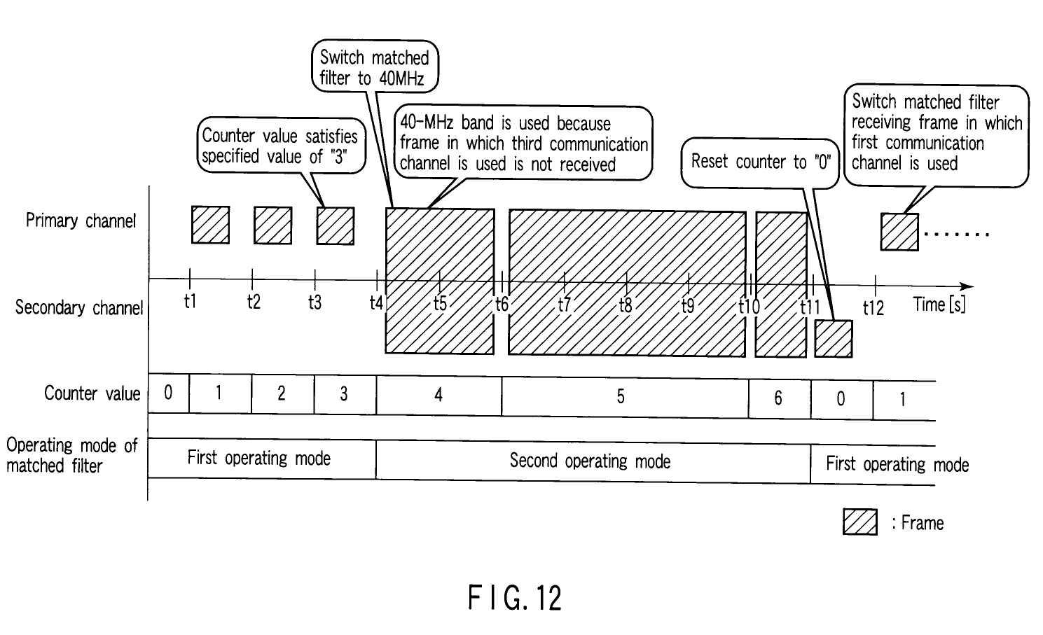

A specific example of the operation of FIG. 11 will be described with reference to FIG. 12. FIG. 12 is a schematic diagram showing a state in which the frame is transmitted and received in the primary channel and the secondary channel, the counter value of the counter 51, and the operating mode of the matched filter 41. FIG. 12 shows the case of the specified value of “3”.

As shown in FIG. 12, it is assumed that the matched filter 41 is in the first operating mode at a time t1. It is also assumed that the frame is received through the primary channel at times t1, t2, and t3. Therefore, the counter value of the counter 51 reaches the specified value of “3” at the time the frame is received at the time t3. That is, the frame of the secondary channel is not received in a period of the times t1 to t3.

Therefore, the switching device 52 switches the matched filter 41 to the second operating mode at a time t4. Because of the low usage frequency of the secondary channel, the wireless LAN system expands the usage band from the 20 MHz band to the 40-MHz band. The wireless LAN system conducts the communication of the 40-MHz band while the matched filter 41 is kept in the second operating mode until the frame of the secondary channel is received at a time t11.

When the frame of the secondary channel is detected at the time t11, the switching device 52 switches the matched filter 41 from the second operating mode to the first operating mode. Then, the matched filter 41 is kept in the first operating mode until the frame is continuously received in the primary channel or the 40-MHz band up to the number of times reaching the specified value.

(Effect)

Thus, the wireless communication apparatus of the third embodiment obtains the following effect (3) in addition to the effects (1) and (2) of the first and second embodiments.

(3) Data communication efficiency data can be enhanced.

In the configuration of the third embodiment, the control unit 50 of the coefficient control unit 42 counts the number of continuously-received frames of the first communication channel and second communication channel while the matched filter 41 functions as the first filter. When the number of continuously-received frames reaches the specified value, the control unit 50 causes the matched filter 41 to function as the second filter.

That is, the control unit 50 causes the matched filter 41 to function as the second filter when the control unit 50 confirms that the secondary channel is not used for a predetermined period. In other words, the control unit 50 estimates a probability that the frame received in the next time exists in the secondary channel by utilizing past statistical information on the frame reception. At the time the control unit 50 can determine that the probability is low, that is, at the time the counter value reaches the specified value, the communication is conducted in the 40-MHz band while the control unit 50 causes the matched filter 41 to act as the second filter. Therefore, the communication can efficiently be conducted in the 40-MHz band to enhance the data communication efficiency.

Once the frame of the secondary channel is received in a period during which the matched filter 41 is caused to act as the second filter, the switching device 52 quickly switches the matched filter 41 to the first operating mode. This enables false frame detection of the secondary channel to be prevented.

The specified value stored in the memory 53 may be a value previously defined at the time of manufacturing or an average of the counter values of the counter 51. That is, the average of the number of counts until the counter value is cleared since the counter 51 starts the counting may be used as the specified value, and the specified value may appropriately be defined.

Thus, in the wireless communication apparatus of the first to third embodiments, the characteristic of the matched filter is controlled according to the presence or absence of the frame transmitted only through the secondary channel, so that the frame detection accuracy can be enhanced in the matched filter.

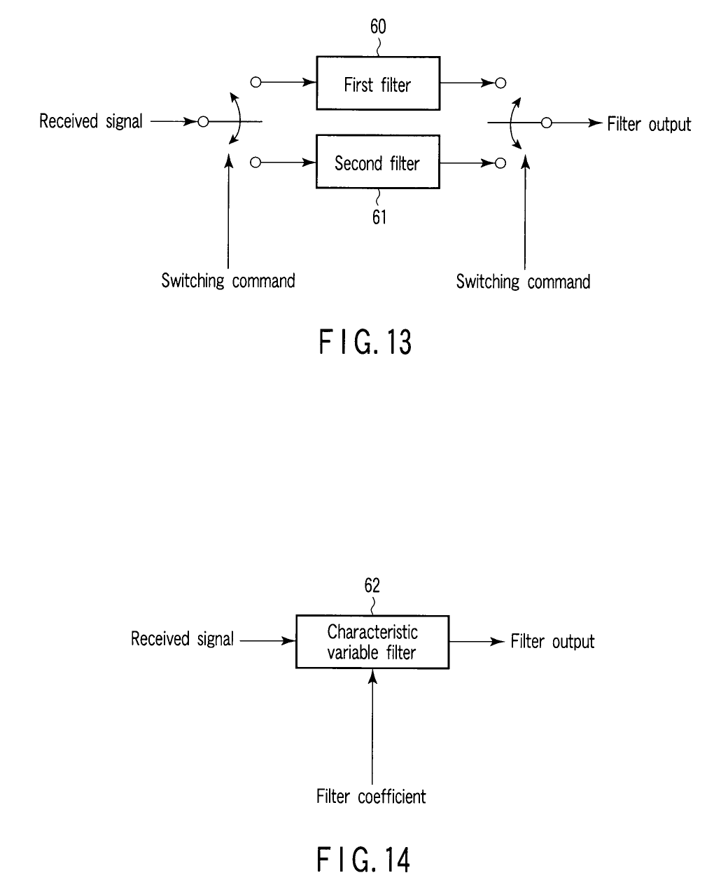

It is only necessary for the matched filter 41 to be able to function as either the first filter, which detects whether or not the frame exists in the first communication channel (primary channel), or the second filter, which detects whether or not the frame exists in the second communication channel (40-MHz band including the primary channel and the secondary channel). There is no limitation to the configuration of the matched filter 41. FIGS. 13 and 14 show examples of the configuration of the matched filter 41.

In the example of FIG. 13, the matched filter 41 includes a first filter 60 and a second filter 61. One of the first filter 60 and the second filter 61 is used according to the instruction of the switching device 52. In the example of FIG. 14, the matched filter 41 includes a filter 62 whose characteristic is variable. The filter 62 exerts the characteristic as the first filter or second filter in response to the filter coefficient supplied from the switching device 52.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless communication apparatus comprising:
a measuring unit which measures an electric power of a received signal to detect whether or not the electric power exceeds a predetermined threshold;
a matched filter which is capable of operating as a first filter and a second filter for the received signal, the first filter being capable of detecting a frame in a first communication channel, the second filter being capable of detecting a frame in a second communication channel, the second communication channel using a frequency band including a frequency band used in the first communication channel and a frequency band used in a third communication channel adjacent to the first communication channel; and
a control unit which determines whether or not the frame exists in the third communication channel according to a detection result of the measuring unit and detection result in the matched filter, the control unit operating the matched filter as the first filter when determining that the frame exists in the third communication channel, the control unit operating the matched filter as the second filter when determining that the frame does not exist in the third communication channel.

2. The apparatus according to claim 1, wherein, in the case where the matched filter is operated as the first filter, the control unit determines that the frame exists in the third communication channel when the matched filter does not detect the frame and when the measuring unit detects that the electric power exceeds the threshold.

3. The apparatus according to claim 1, further comprising a demodulation unit which demodulates the frame to analyze a frame header in the frame, and outputs analytical result to the control unit,
wherein, in the case where the matched filter is operated as the second filter, the control unit determines that the frame exists in the third communication channel when the demodulation unit outputs an error as the analytical result.

4. The apparatus according to claim 1, wherein in the case where the matched filter is operated as the first filter, the control unit counts the number of times at which the frame is received through the first communication channel and the second communication channel, and
the control unit switches the matched filter from the first filter to the second filter when the counting result exceeds a specified value.

5. The apparatus according to claim 4, wherein, in the case where the matched filter is operated as the second filter, the control unit switches the matched filter from the second filter to the first filter once the frame is detected in the third communication channel.

6. The apparatus according to claim 1, wherein the matched filter determines whether the frame exists in the first communication channel or second communication channel based on a preamble of the frame.

7. The apparatus according to claim 1, wherein the measuring unit determines that the frame is transmitted through one of the first to third communication channels when detecting the electric power having an intensity not lower than the threshold with respect to a background noise, and
the measuring unit notifies the control unit that the frame is transmitted through one of the first to third communication channels.

8. The apparatus according to claim 7, wherein the control unit controls the matched filter based on whether or not the frame exists when the measuring unit makes the notification.

9. The apparatus according to claim 1, wherein the frequency band used in the first communication channel has a 20-MHz bandwidth and the frequency band used in the second communication channel has a 40-MHz bandwidth.

10. A wireless communication method which is capable of using a first communication channel and a second communication channel, the second communication channel having a frequency band including a frequency band used in the first communication channel and a frequency band used in a third communication channel adjacent to the first communication channel, the method comprising:
measuring a signal intensity of a received signal;
determining whether or not a frame exists in the third communication channel when the signal intensity is not lower than a predetermined threshold; and
optimizing a matched filter which detects the frame for the first communication channel when the frame exists in the third communication channel, or optimizing the matched filter for the second communication channel when the frame does not exist in the third communication channel.

11. The method according to claim 10, wherein it is determined that the frame exists in the third communication channel when the matched filter optimized for the first communication channel does not detect the frame.

12. The method according to claim 10, wherein it is determined that the frame exists in the third communication channel when an analytical result of the received signal is an error.

13. The method according to claim 10, further comprising:
counting the number of times at which the frame is received through the first communication channel or second communication channel; and
clearing the number of times when the frame is received through the third communication channel,
wherein the matched filter is switched from a first state optimized for the first communication channel to a second state optimized for the second communication channel when the number of times reaches a specified value and when the matched filter is optimized for the first communication channel.

14. The method according to claim 13, wherein, in the case where the matched filter is optimized for the second communication channel, the matched filter is switched from the second state to the first state once the frame is received through the third communication channel.

15. The method according to claim 10, wherein the matched filter determines whether the frame exists in the first communication channel or second communication channel based on a preamble of the frame.

16. The method according to claim 10, wherein the frequency band used in the first communication channel has a 20-MHz bandwidth and the frequency band used in the second communication channel has a 40-MHz bandwidth.
